(19) United States
(12) Patent Application Publication
(10) Pub. No.: US 2014/0056788 A1
(43) Pub. Date: Feb. 27, 2014

(54) METHOD FOR THE MODEL-BASED FEEDBACK CONTROL OF AN SCR SYSTEM HAVING AT LEAST ONE SCR CATALYTIC CONVERTER

(71) Applicant: AVL List GmbH, Graz (AT)

(72) Inventors: Bernd BREITSCHAEDEL, Graz (AT); Bernhard BREITEGGER, Lieboch (AT)

(73) Assignee: AVL LIST GMBH, Graz (AT)

(21) Appl. No.: 13/969,584

(22) Filed: Aug. 18, 2013

(30) Foreign Application Priority Data
Aug. 21, 2012 (AT) A 50330/2012

(51) Int. Cl. B01D 53/94

(52) U.S. Cl. CPC B01D 53/9495
USPC 423/212

(57) ABSTRACT

A method for a model-based feedback control of an SCR system having at least one SCR catalytic converter. An SCR catalytic converter model of the SCR catalytic converter is used to control an injection of a reductant upstream of the SCR catalytic converter. In the SCR catalytic converter model, at least one reduction rate based on an Arrhenius approach and/or an SCR efficiency of at least one relevant reaction in the SCR catalytic converter is calculated. Deviations between a real system behavior and a simulated system behavior are adjusted using adaptation logic. In order to minimize the deviations between the model and the real system behavior and to achieve enhanced control accuracy, at least one adjustment parameter is used in the calculation of at least one reaction rate and/or the SCR efficiency, the adjustment parameter taking into consideration deviations between the real system behavior and the simulated system behavior.

### CROSS-REFERENCE TO RELATED APPLICATIONS

The present application claims priority 35 U.S.C. §119 to Austrian Patent Application No. 50330/20120 (filed on Aug. 21, 2012), which is hereby incorporated by reference in its entirety.

### TECHNICAL FIELD

Embodiments of the invention relate to a method for the model-based feedback control of an SCR system having at least one SCR catalytic converter. A physical SCR catalytic converter model of the SCR catalytic converter is structurally configured to control the injection of a reductant upstream of the SCR catalytic converter. In the SCR catalytic converter model at least one reduction rate \dot{r}-based on an Arrhenius approach and/or an SCR efficiency of at least one relevant reaction in the SCR catalytic converter is calculated. Deviations between real system behavior and simulated system behavior are adjusted by means of adaptation logic.

### BACKGROUND

It is known to perform a model-based SCR feedback control in SCR systems with at least one SCR catalytic converter. In this case, a physical model of the SCR catalytic converter is implemented in the feedback control. This observer model is used as a so-called virtual sensor in order to determine system quantities which may not be detected directly by way of measurement. Deviations between the real system behavior and the simulated model values must always be expected in the application. That is why adaptation logic needs to be implemented, which on the basis of quantities accessible by measurement will identify the model error and will suitably adjust the model values.

The model of the SCR catalytic converter includes modules for the calculation of the SCR efficiency, for NH3 oxidation and for NH3 absorption and NH3 desorption. SCR efficiency shall be understood here as the efficiency in the conversion of nitrogen oxides (NOx) into harmless components (N2 and water).

The documents DE 103 47 130 A1, DE 103 47 131 A1 and DE 103 47 132 A1 respectively disclose a method for the estimation of a quantity of ammonia stored in a urea-based SCR catalytic converter on the basis of a dynamic model of the catalytic converter. The model considers the chemical and physical properties of the catalytic converter, such as volume of the catalytic converter, the number of available ammonia storage locations, adsorption and desorption dynamics, as well as poisonings, thermal ageing and operating temperatures of the catalytic converter, and generates the estimation on the basis of a quantity of a reductant injected into the catalytic converter for facilitating the NOx reduction and on the basis of a measured value of NOx in an exhaust-gas mixture downstream of the catalytic converter. The estimated quantity of stored ammonia will be used in order to maintain the desired ammonia storage quantity in such a way that a maximum NOx conversion efficiency is achieved in conjunction with minimal escape of ammonia.

The publications DE 10 2010 002 620 A1, DE 10 2011 105 626 A1 and DE 10 2009 027 184 A1 describe methods for the compensation of the errors in the estimation of the stored NH3 by adaptation of the quantity of dosed reductant.

DE 10 2008 041 603 A1 describes a method for the direct adaptation of errors in the stored NH3.

DE 10 2008 036 884 A1 describes a method for the compensation of errors in the stored NH3, and for the compensation of errors in the quantity of the reductant.

No method is known from the state of the art which compensates errors in the SCR efficiency.

### SUMMARY

In accordance with embodiments, deviations are minimized between the model and the real system behavior. Enhanced control accuracy is also achieved.

In accordance with embodiments, this is achieved in such a way that at least one adjustment parameter k will be included in the calculation of at least one reaction rate \dot{r} and/or an SCR efficiency, which adjustment parameter k considers deviations between a real system behavior and the simulated system behaviour. The adjustment parameter is determined as a function of at least one operating parameter of the SCR system.

Embodiments are related to a method for a model-based feedback control of an SCR system having at least one SCR catalytic converter, the method including at least one of: using a physical SCR catalytic converter model of the SCR catalytic converter to control an injection of a reductant upstream of the SCR catalytic converter; calculating, using the SCR catalytic converter model, at least one reduction rate and/or an SCR efficiency of at least one relevant reaction in the SCR catalytic converter; and adjusting deviations between a real system behavior and a simulated system behavior using adaptation logic, wherein: (i) at least one adjustment parameter is included in calculating the at least one reaction rate \dot{r} and/or an SCR efficiency, (ii) the at least one adjustment parameter considers deviations between the real system behavior and the simulated system behavior, and (iii) the at least one adjustment parameter is determined as a function of at least one operating parameter of the SCR system

Embodiments are related to a method that includes at least one of: controlling an injection, using a SCR catalytic converter model of an SCR catalytic converter of an SCR system, of a reductant upstream of the SCR catalytic converter; calculating a reduction rate of a reaction in the SCR catalytic converter using a SCR catalytic converter model, and which includes determining a first adjustment parameter as a function of an operating parameter of the SCR system; and adjusting deviations between a real system behavior and a simulated system behavior, wherein the adjustment parameter considers deviations between the real system behavior and the simulated system behavior.

Embodiments are related to a method of controlling an SCR system having an SCR catalytic converter, the method including at least one of: controlling an injection, using an SCR catalytic converter model, of a reductant upstream of the SCR catalytic converter; calculating a reduction rate and an SCR efficiency of a reaction in the SCR catalytic converter using the SCR catalytic converter model, the calculating including determining a first adjustment parameter as a function of an operating parameter of the SCR system; and adjusting deviations between a real system behavior and a simulated system behavior, wherein the adjustment parameter considers deviations between the real system behavior and the simulated system behavior.

In accordance with embodiments, at least one reaction rate \dot{r} is determined according to the following equation:

$$\dot{r} = K \cdot k ( {P}_{1} , {P}_{2} ) \cdot exp ( \frac{- E}{R \cdot T} ) \cdot f ( {C}^{->} , \vec{Z} )$$

In the equation, \dot{r} is the reaction rate [mol/m²s], k(P₁, P₂) is the adjustment parameter, P₁, P₂ are the observed operating parameters of the SCR system, K is a pre-exponential term for the reaction, E is the activation energy for the reaction [J/mol], R is the universal gas constant [J/mol/K], T is the temperature [K], \vec{C} is the vector with concentration of gas species such as NO, NO₂, NH₃, O₂ [mol/m³], and Z̅ is the vector with loadings of surface species such as NH₃, HC [mol/m²].

The SCR efficiency is determined from these reaction rates \dot{r}. The SCR efficiency η_{SCR} is calculated from the NOₓ concentrations at the inlet and the outlet of the SCR system.

$${η}_{SCR} = \frac{{c}_{NOx , US} - {c}_{NOx , DS}}{{c}_{NOx , US}} \cdot 100 \% ,$$

wherein η_{SCR} is the SCR efficiency (%), c_{NOx,US} is the NOₓ concentration before (upstream of) the SCR system [mol/m³], and c_{NOxDS} is the NOₓ concentration after (downstream of) the SCR system [mol/m³].

Numerical modeling is therefore required, which calculates the concentrations after the SCR catalytic converter from the calculated reaction rates and the concentrations before the SCR catalytic converter. Models of this kind are already known from the state of the art and are therefore not part of embodiments of the invention. DE 103 47 130 A1 describes such a numerical model for example, but numerous changes or modifications of this numerical model are possible.

The adjustment parameter k may depend not only on two operating parameters as in this example, but also only on one operating parameter or even more operating parameters. An adjustment parameter k is inserted into the mathematical formulation of the reaction rates \dot{r}. This adjustment parameter k is defined as a function of one or several operating parameters.

In accordance with embodiments, an adjustment parameter is determined as a quotient of the efficiency calculated from the measured SCR efficiency and the SCR model. The temperature of the SCR catalytic converter and/or the temperature of an oxidation catalytic converter arranged upstream of the SCR catalytic converter in the same exhaust strand may be considered as an operating parameter.

A characteristic curve is obtained for the adjustment parameter k depending on one operating parameter, and a characteristic map is obtained depending on two operating parameters. This characteristic curve or characteristic map is therefore saved as a data field with discrete data points. The adjustment parameter k is advantageously defined as a function of an operating parameter of the SCR system by a characteristic curve or as a function of two operating parameters by a characteristic map with data points. An adjustment parameter which is not positioned precisely on the data points may be calculated in a weighted manner from the respective data point values via the distance from adjacent data points.

An adaptation logic minimizes the deviation between the model value and real behavior in that it adjusts those values on the adjacent data points in the characteristic curve or in the characteristic map which are situated closest to the current operating point. When the corrective factor is stored in form of a characteristic curve, a so-called 2-point adaptation may be used. In this case, the two data points are adjusted simultaneously which are situated closest to the current operating point.

If the adjustment parameter is stored in form of a characteristic map, a so-called 4-point adaptation may be used. In this case, four data points are adjusted simultaneously which are situated closest to the current operating point. It is especially advantageous if those values at the data points which are closest to the respectively current operating point are adjusted in a self-learning process to the real behavior in that a third adjustment parameter is calculated in the adaptation from the second adjustment parameter calculated from the characteristic curve or the characteristic map and the measured first adjustment parameter, in which the adjacent data points are updated in accordance with embodiments on the basis of the third adjustment parameter and the respective weighting factors determined on the basis of the distances from the adjacent data point values. The temporal change in this third adjustment parameter and subsequently the data point values calculated therefrom may be realized by feedback filters, e.g., a filter with infinite impulse response (IIR filter).

In accordance with embodiments, the method allows minimizing the deviations between the physical model and the real system behavior. As a result, enhanced control accuracy and enhanced control quality are achieved. This leads to high SCR efficiencies in combination with low NH3 emissions. Furthermore, application of the method in accordance with embodiments allows detecting production fluctuations in the installed catalytic converters and changes in the behavior of the catalytic converter (e.g., by ageing effects) by way of control technology. The evaluation of the adjustment parameters may further be considered in the diagnostic functions of an on-board diagnostic system.

### DRAWINGS

Embodiments of the invention are explained in detail with reference to the accompanying drawings, in which:

FIG. 1 schematically illustrates the hardware and software of an SCR system in accordance with embodiments.

FIG. 2 illustrates the dependence of the SCR efficiency on the adjustment parameter k.

FIG. 3 illustrates the SCR efficiency diagram with characteristic curves for the adjustment parameter and the real system behavior.

FIG. 4 illustrates the adjustment parameter k depending on an operating parameter.

FIG. 5 illustrates a characteristic map for adjustment parameters depending on two operating parameters.

FIG. 6 illustrates a 2-point interpolation for an adjustment parameter k.

FIG. 7 illustrates a 2-point adaptation for an adjustment parameter k.

FIG. 8 illustrates a 4-point interpolation for an adjustment parameter k.

FIG. 9 illustrates a 4-point adaptation for an adjustment parameter k, and

FIG. 10 illustrates a rewriting process of correct values to individual data points by way of example.

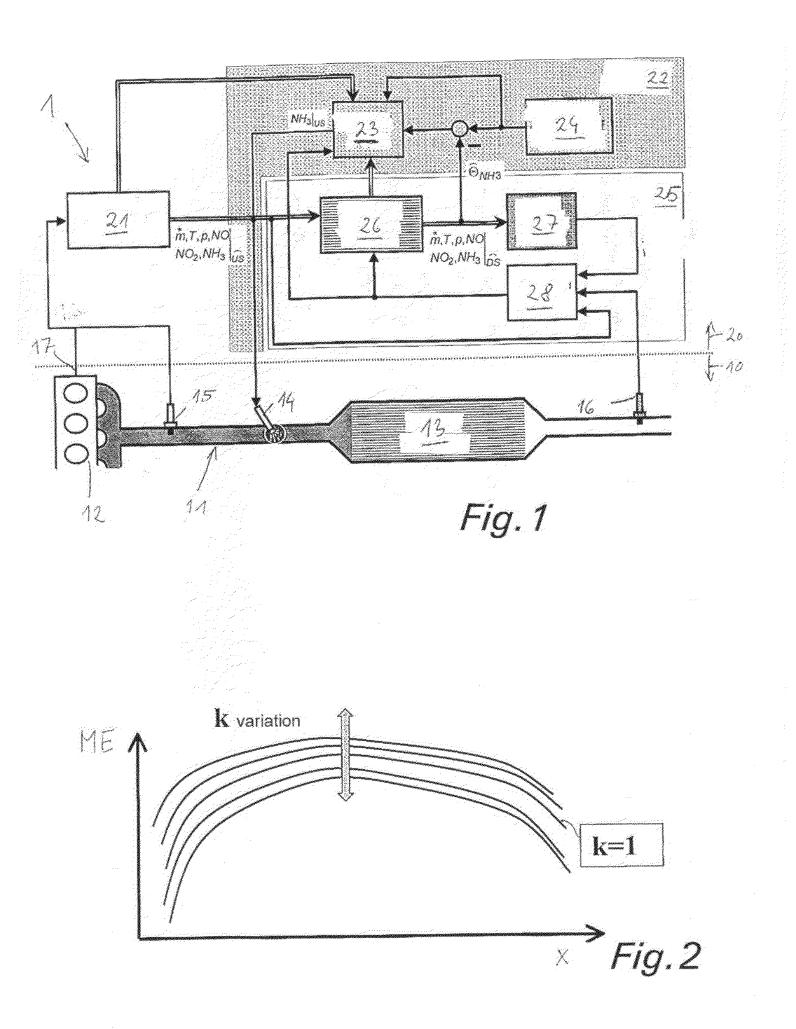

### DESCRIPTION

In accordance with embodiments, a model-based SCR system 1 includes hardware 10 and software 20 in operative communication. Hardware 10 includes an exhaust strand 11 of an internal combustion engine 12 with an SCR catalytic converter 13, and an injection device 14 for a reductant such as urea which is arranged upstream of the SCR catalytic converter 13. One respective NOx sensor 15, 16 is arranged upstream US and downstream DS of the SCR catalytic converter 13. Additional sensors 17 are configured to detect the temperature T, the mass flow \dot{m}, the pressure p or the like in the exhaust strand 11 upstream US or downstream DS of the SCR catalytic converter 13. A diesel oxidation catalytic converter (not illustrated) may further be arranged in the exhaust strand 11 before the SCR catalytic converter 13.

The software 20 is configured to calculate a calculated SCR efficiency (ηSCR_mess) from the signals of the two NOx sensors 15, 16. The software 20 includes an exhaust gas emission model 21, a setpoint controller 22 with a controller core 23 and a control element 24 for the setpoint value, tuning values and maximum values, and an observer 25 with an SCR catalytic converter model 26, an NOx sensor model 27 and an adaptation logic 28. The data of the sensors 15 and 17 are supplied to the exhaust gas emission model.

The SCR catalytic converter model 26 is used for the feedback control of the SCR catalytic converter 13. The observer 25 acts as a virtual sensor in order to determine system quantities which may not be measured directly. Deviations between real system behavior and simulated model values must always be expected in the application. That is why an adaption logic 28 needs to be implemented, which on the basis of quantities that are accessible by measurement will identify the model error and adjust the model values in a suitable manner.

The SCR catalytic converter model 26 is based on a physical approach, i.e., the rates of the relevant reactions are calculated individually. So-called Arrhenius approaches are used in this case, for example, in such a formulation:

$$\begin{matrix}4 {NH}_{3} + 2 NO + 2 {NO}_{2} -> 4 {N}_{2} + 6 {H}_{2} O & ( 1 ) \\ \dot{r} = K \cdot exp ( \frac{- E}{R \cdot T} ) \cdot {C}_{NO 2} \cdot {C}_{NO} \cdot {Z}_{NH 3} & ( 2 )\end{matrix}$$

wherein \dot{r} is the reaction rate [mol/m2s], K is a pre-exponential term for the reaction, E is the activation energy for the reaction, R is the universal gas constant [J/kmol/], T is the temperature [K], Cₓ is the concentration of the species x [mol/m^{3], and Z}_{NH3} is the surface loading of NH₃ [mol/m²].

Due to the limited computing capacities of current control devices in which such processes for controlling an SCR system are implemented, such expressions are frequently implemented at least in part in form of characteristic curves, characteristic maps or the like. The method in accordance with the invention may also be applied to such implementations analogously.

In order to enable the adjustment of the SCR catalytic converter model 26, an adjustment parameter k is inserted into one or several reaction rates \dot{r}. The result of the model may be influenced by varying the adjustment parameter k:

$$\dot{r} = K \cdot k ( {P}_{1} , {P}_{2} ) \cdot exp ( \frac{- E}{R \cdot T} ) \cdot {C}_{NO 2} \cdot {C}_{NO} \cdot {Z}_{NH 3} \qquad ( 3 )$$

wherein k(P₁, P₂) is the adjustment parameter, P₁, P₂ is the observed operating parameter of the SCR system, K is a pre-exponential term for the reaction, E is the activation energy for the reaction [J/mol], R is the universal gas constant [J/mol/K], T is the temperature [K], Cₓ is the concentration of the species x [mol/m³], and Z_{NH3} is the surface loading of NH₃ [mol/m²].

FIG. 2 schematically shows the dependence of the model result ME on an influencing variable x in variation of the adjustment parameter k.

The deviation between the measured data and the model may necessitate different adjustment factors k for different values of the input parameters. That is why k is defined as a function of one or two operating parameters P₁, P₂:

$$\dot{r} = K \cdot k ( {P}_{1} , {P}_{2} ) \cdot exp ( \frac{- E}{R \cdot T} ) \cdot {C}_{NO 2} \cdot {C}_{NO} \cdot {Z}_{NH 3} \qquad ( 4 )$$

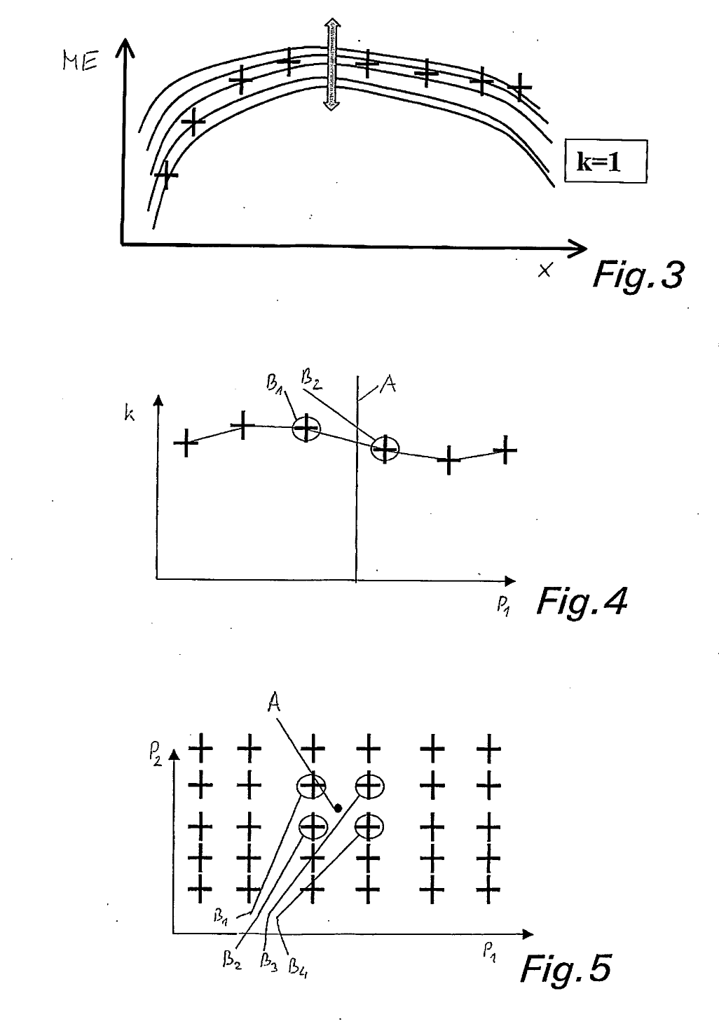

FIG. 3 shows a model result ME (e.g. SCR efficiency) depending on an influencing variable x (operating parameter P₁), wherein points with real system behavior are entered with “+”. An adjustment to the real system behavior may occur by varying the adjustment parameter k.

A characteristic curve is obtained for k depending on an operating parameter P1. A characteristic map is obtained for k depending on two operating parameters. This characteristic curve or the characteristic map is stored as a data field with discrete data points.

The adaptation logic 28 minimizes the deviation between the model value and the real behavior, in that it adjusts those data points in the characteristic curve or in the characteristic map which are closest to the current operating point. FIG. 4 shows a 2-point adaptation for a characteristic curve, wherein A designates the current operating point, and B₁ and B₂ the modified data points which are closest to the current operating point A. FIG. 5 shows in an analogous manner a 4-point adaptation in a characteristic map, comprising the current operating point A and the modified data points B₁, B₂, B₃, B₄.

The adaptation consists of the steps of interpolation and the actual adaptation, wherein the interpolation is always active and the adaptation is selectively active.

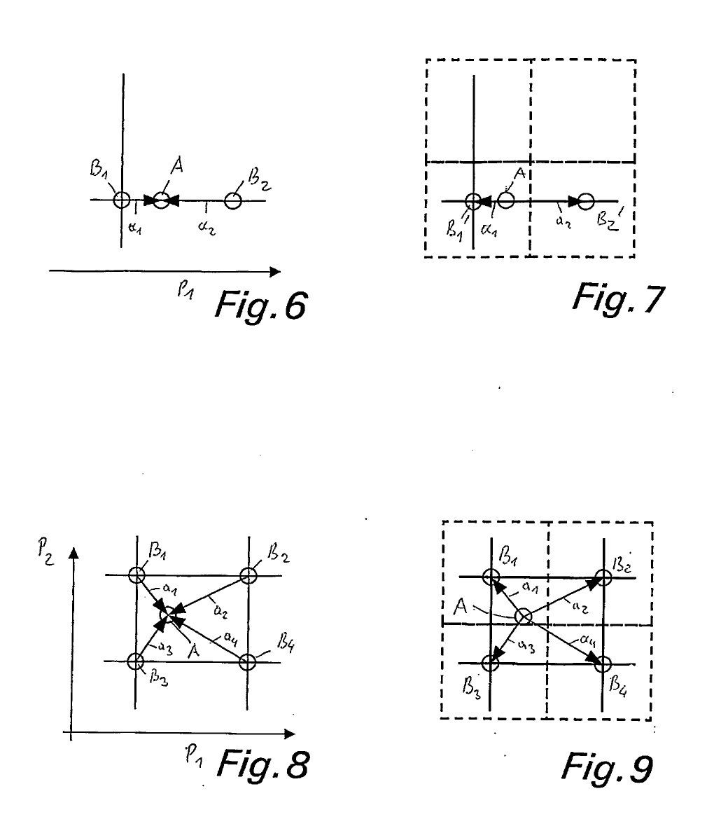

FIGS. 6 and 7 illustrate 2-point interpolation (FIG. 6) and a 2-point adaptation (FIG. 7) on the basis of an example for a characteristic curve. The SCR efficiency η_{SCR} will be used below as the observed model result ME.

In accordance with embodiments, a first adjustment parameter k may be determined as a quotient of the measured sensor-based SER efficiency η_{SCR, mess} and the efficiency η_{SCR,model} of defined operating conditions as calculated from the model depending on one or several operating parameters P₁, P₂. The temperature of the SCR catalytic converter will be considered as the first operating parameter P₁, and the temperature of a diesel oxidation catalytic converter as the second operating parameter P₂.

$$k = \frac{{η}_{SCR , mess}}{{η}_{SCR , model}} \qquad ( 5 )$$

In the case of a single operating parameter P₁, the SCR efficiency η_{SCR,model} is calculated via a characteristic curve, and via a characteristic map in the case of two influencing variables.

A second adjustment parameter kSCR,corr2 will be calculated in a 2-point interpolation (characteristic curve) or a 4-point interpolation (characteristic map) via the distances a1, a2, a3, a4 from the two or four adjacent data points B1, B2, B3, B4, as demonstrated in FIGS. 6 and 8.

In the adaptation illustrated in FIGS. 7 and 9, a new third adaptation parameter kSCR,corr3 is calculated from this second adjustment parameter kSCR,corr2 and the measured first adjustment parameter k, which third adjustment parameter is written with the same weighting factors (distances a1, a2, a3, a4) to the data points B1, B2, B3, B4 on the respective data point values (two or four) B1, B2, B3, B4. The calculation of this third adjustment parameter kSCR,corr3 is performed similar to a feedback IIR filter in order to enable slow adjustment to the measured SCR efficiency ηSCR,mess. The adjustment parameter kSCR,corr3 may also be treated as a difference.

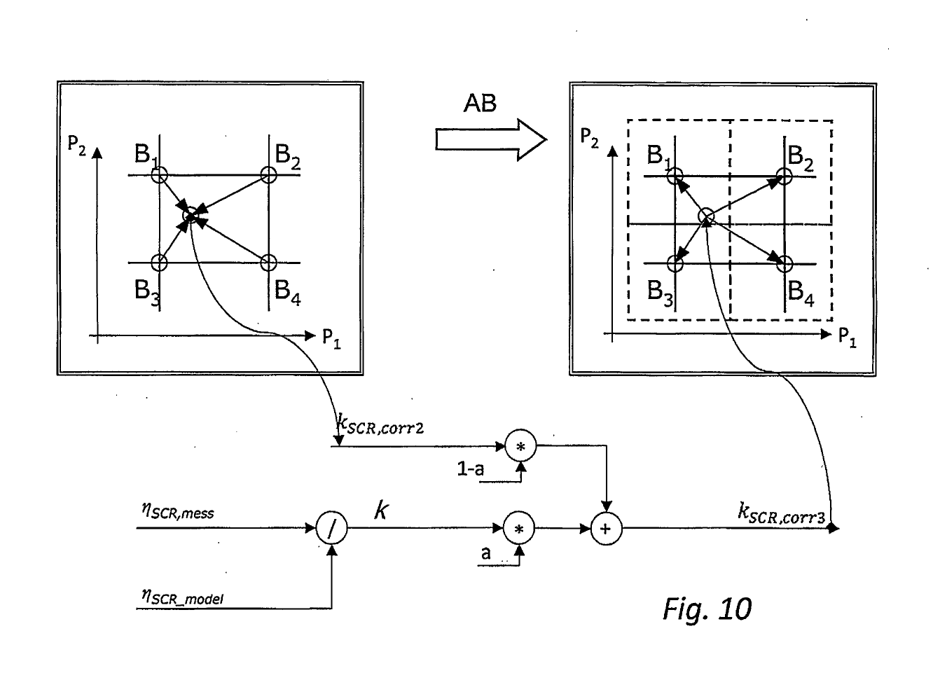

The rewriting of the corrected values to the individual data points may selectively be allowed or suppressed by suitable activation conditions AB. This process is shown by way of example for a 4-point interpolation on a 4-point adaptation in FIG. 10, in which the currently calculated corrected value kSCR.corr1 is weighted with the filter constant a by multiplication with a and is added to the stored corrective value kSCR.corr2 which is weighted with 1−a by multiplication. This leads to the new corrective value kSCR.corr3. The data points B1, B2, B3, B4 of the 4-point adaptation shown in FIG. 10 in the right-hand section may be activated or not (optionally partly) via activation conditions AB. The data points B₁, B₂, B₃, B₄ of the 4-point adaptation shown in the left-hand section are always active.

Although embodiments have been described herein, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method for a model-based feedback control of an SCR system having at least one SCR catalytic converter, the method comprising:
using a physical SCR catalytic converter model of the SCR catalytic converter to control an injection of a reductant upstream of the SCR catalytic converter;
calculating, using the SCR catalytic converter model, at least one reduction rate and/or an SCR efficiency of at least one relevant reaction in the SCR catalytic converter; and
adjusting deviations between a real system behavior and a simulated system behavior using adaptation logic,
wherein:
at least one adjustment parameter is included in calculating the at least one reaction rate \dot{r} and/or an SCR efficiency,
the at least one adjustment parameter considers deviations between the real system behavior and the simulated system behavior, and
the at least one adjustment parameter is determined as a function of at least one operating parameter of the SCR system.

2. The method of claim 1, wherein the at least one reaction rate \dot{r} is calculated in accordance with an equation:
$$\dot{r} = K \cdot k ( {P}_{1} , {P}_{2} ) \cdot exp ( \frac{- E}{R \cdot T} ) \cdot f ( {C}^{->} , \vec{Z} ) ,$$
wherein \dot{r} is the reaction rate [mol/m²s], k(P₁, P₂) is the adjustment parameter, P₁, P₂ are the observed operating parameters of the SCR system, K is a pre-exponential term for the reaction, E is the activation energy for the reaction [J/mol], R is the universal gas constant [J/mol/K], T is the temperature [K], \vec{C} is the vector with concentration of gas species such as NO, NO₂, NH₃, O₂[mol/m³], and Z̅ is the vector with loadings of surface species [mol/m²].

3. The method of claim 1, wherein the at least one reduction rate \dot{r} is calculated based on an Arrhenius approach.

4. The method of claim 1, wherein the simulated system behavior comprises the SCR efficiency.

5. The method of claim 1, wherein the adjustment parameter is determined as a quotient of measured SCR efficiencies and an efficiency calculated using the SCR catalytic converter model.

6. The method of claim 2, wherein at least one operating parameter comprises a temperature of the SCR catalytic converter.

7. The method of claim 6, wherein at least one operating parameter comprises a temperature of an oxidation catalytic converter upstream of the SCR catalytic converter.

8. The method of claim 7, wherein the adjustment parameter is represented as a function of the at least one operating parameter by a characteristic curve or a characteristic map having a plurality of data points.

9. The method of claim 8, further comprising calculating a second adjustment parameter using the data point values weighted from a distance between adjacent data points.

10. The method of claim 9, wherein the adjustment parameter is corrected using the second adjustment parameter.

11. The method of claim 10, wherein the data points which are closest to a current operating point are adjusted to the real system behavior.

12. The method of claim 11, further comprising calculating a third adjustment parameter in an adaptation from the adjustment parameter and the second adjustment parameter.

13. The method of claim 12, wherein the adjacent data points are updated in accordance with the third adjustment parameter.

14. The method of claim 13, further comprising calculating weighting factors determined on a basis of the distances between the adjacent data points.

15. The method of claim 14, wherein the update of the adjacent data points is carried out using at least one filter with infinite impulse response.

16. The method of claim 15, wherein the update of the data points is selectively permitted using activation conditions.

17. The method of claim 15, wherein the update of the data points is selectively suppressed using activation conditions.

18. A method comprising:
controlling an injection, using an SCR catalytic converter model of an SCR catalytic converter of an SCR system, of a reductant upstream of the SCR catalytic converter;
calculating a reduction rate of a reaction in the SCR catalytic converter using the SCR catalytic converter model, and which includes determining a first adjustment parameter as a function of an operating parameter of the SCR system; and
adjusting deviations between a real system behavior and a simulated system behavior,
wherein the adjustment parameter considers deviations between the real system behavior and the simulated system behavior.

19. A method of controlling an SCR system having an SCR catalytic converter, the method comprising:
controlling an injection, using an SCR catalytic converter model, of a reductant upstream of the SCR catalytic converter;
calculating a reduction rate and an SCR efficiency of a reaction in the SCR catalytic converter using the SCR catalytic converter model, the calculating including determining a first adjustment parameter as a function of an operating parameter of the SCR system; and
adjusting deviations between a real system behavior and a simulated system behavior,
wherein the adjustment parameter considers deviations between the real system behavior and the simulated system behavior.
